(19) United States
(12) Patent Application Publication
(10) Pub. No.: US 2011/0208787 A1
(43) Pub. Date: Aug. 25, 2011

(54) Method and device for continuously aggregating and redistributing personalized electronic information for display on multiple internet-enabled devices

(76) Inventor: Adam L. Sidy, West Hollywood, CA (US)

(21) Appl. No.: 12/930,568

(22) Filed: Jan. 11, 2011

Related U.S. Application Data
(60) Provisional application No. 61/335,697, filed on Jan. 11, 2010.

(51) Int. Cl. G06F 17/30

(52) U.S. Cl. 707/809; 707/E17.005

(57) ABSTRACT

A system uses applications and electronic data storage to continuously aggregate and redistribute personalized electronic information. The system collects data or information from a large variety of internet-based content sources, stores that information, and continuously refreshes it. Users select what information they wish to receive. That continuously-updated information is, in turn, continually sent to one or more of the user's interne enabled devices and continuously displayed in a format chosen by the user, such as a continuous ribbon moving across the bottom of the user's device.

This application is based on provisional application Ser. No. 61/335,697, filed Jan. 11, 2010, by inventor Adam L. Sidy.

### FIELD OF THE INVENTION

This invention, currently known and implemented under the name MetaGogue (“MG”), relates to continuously aggregating information, typically from a number of disparate electronic content sources like websites, e-mails, subscriptions, and social networking sites, and then redistributing that information into a continuous single source for display on an Internet-enabled electronic device, such as a desktop or laptop computer, a mobile phone, a smart phone, a tablet, or even the display screen inside an automobile.

### BACKGROUND OF THE INVENTION

Since at least the dawn of the industrial age, the parallel development of society, communication, and technology has generated an ever-increasing demand for greater amounts of information delivered at faster and faster speeds and to the farthest reaches of the planet. From the telegraph to the Pony Express to Bell's telephone, and from CB radios to the Telstar satellite to the smart phone and tablet, people are constantly searching for ways to receive a larger quantity and wider variety of information delivered wherever, whenever, and as quickly as possible. Gamblers and sports fans want instantaneous scores of athletic contests. Bankers and financiers want to hear the latest pronouncements of the Federal Reserve or the latest stock prices. Travelers want constantly updated weather reports and up to the minute flight status. Friends and business associates want the latest information from personally oriented or business oriented social networking sites.

Many individuals want all that information and more. Unfortunately, rapidly obtaining that information, and only that information, in a convenient manner and identical form, and with continual updates, is not considered as easy as it would seem. News tickers have appeared outside on buildings for decades, and more recently they have appeared on television broadcasts and Internet sites. These tickers, however, may not contain the specific information sought by a particular individual, nor might the information even be available on other information sources. For example, some Internet news organizations can send their users certain limited, pre-selected content on a periodic basis. ESPN Mobile Products offers ESPN Alerts, which periodically sends current sports scores and news via text messages to a subscriber's mobile phone. An iPhone application periodically uploads sports updates while also streaming an audio sports program. Nevertheless, information-seeking, Internet-enabled electronic device users chronically confront the problem that each information source has its own specific content and its own method and limitations of information distribution. A need remains for a way by which Internet-enabled electronic device users can readily obtain from multiple, disparate sources their own personally selected, specific and continually updating information, regardless of the kind of information desired, without having to connect to each individual information source, methodically search for their desired unique choice, and then repeatedly revisit that site for updated information, if in fact it is updated.. Users then require a means by which their personally selected information can be automatically and continuously updated and delivered to their internet-enabled devices,

Another problem associated with continuously acquiring multiple types of disparate and updated information is that there are numerous and different types of Internet-enabled electronic devices. Many devices have hardware and software that differ in both general function and in engineering features. In some cases these differences result from a difference in manufacturers, in other cases simply a difference in one manufacturer's own devices. These differences, whether hardware or software, result in different platforms. For example, there are Apple and Dell desktop and laptop computers, i.e. hardware platforms, and Apple, Linux, and Windows operating systems, i.e. OS platforms. Likewise, there are phones and tablets manufactured by a host of different companies, such as HTC, Nokia, Motorola, Apple, Samsung, and LG. Some manufacturers may produce the same physical device with different operating systems, In addition, Internet-enabled electronic devices once considered futuristic will soon appear, such as electronic screens on the outside of refrigerator doors that will allow a user not only to access the Internet but even to query the refrigerator's contents via the UPC codes.

### SUMMARY OF THE INVENTION

This invention solves the preceding problems by continuously providing aggregated, updated information, selected by the user, on a real-time, cross platform basis. The invention obtains information from a plurality of content sources, regardless of any one source's individual content and method'of information distribution. The invention sends the user's selected information over a multitude of hardware and software platforms. In one preferred version the user's selected information appears in a ribbon-esque animated graphic running across (ribbon will be movable, and less similarity to other such info streams) the screen of any of the user's Internet-enabled electronic devices. The consolidation of the selectable information in one place, and the subsequent transmission to the user of their selected information as a real-time data stream viewable as a single source in identical or almost identical format across different platforms, speeds and simplifies an individual's ability to quickly and continuously receive updated information without a lengthy interruption or time consuming efforts. The information appears automatically without a user continually having to surf different Internet websites and flip from web page to web page, or individually open multiple feeds that contain updates, or suffer similar diversions. Glancing quickly at the ribbon running across the bottom of a screen furnishes all the desired information.

In a preferred embodiment of the invention a user can modify the ribbon content without returning to his home page. For example, in a touch screen device, the user can touch and freeze a baseball score, which would then present a variety of options, including deselecting a game when it has been concluded. In another preferred aspect of the invention the user can acquire details beyond the scope of the actual ribbon content as the ribbon content is html-linked backed to the original content provider. For example, on a desktop computer the user can mouse click a football score, and be instantly sent to the content provider's expanded web page coverage for the game, A significant commercial advantage of the invention is that audio and html-linked stylized graphic logo advertisements can be inserted in the ribbon for one level of advertising and clicked through back to their sources for another, or a user can opt to pay a premium to not receive any advertising altogether. In addition, other advertising options are content providers paying to be positioned as a preferred content provider on the user's selection page, or sponsoring a promotion that enhances the appearance of the ribbon. Thus, the invention has the capability of generating advertising revenue.

To utilize the invention, the user goes to one destination on the Internet, the www.metagogue.com website, and selects from a broad array of popular information categories, such as sports, weather, or stock trading, and then a particular content source, such as ESPN.com or Sportsline-cbssports.com. Continuing with the sports analogy, the user selects an event, which is a specific occurrence like a baseball game, then selects event attributes, which identify the information details the user wishes to appear on his or her device. For a baseball game the user may wish to receive the team names, the inning, the score, and the opposing pitchers. The event data from all the available content sources is continuously aggregated and compiled in a database. The specific event data for all of the user's selected events and event attributes are then identified in the database and configured for transmission to the user's display devices. In other words, the desired information, not just sports but all other categories and events the user personally selects, appears to originate from a single source, when in fact it has been aggregated from several disparate sources, reconfigured, and then delivered to the user. The event data then appears onscreen in the ribbon display application. The term “crawl” can be used to refer to the actual text of the event data from the user requested information that scrolls inside the ribbon.

In one preferred version of the invention the user controls a number of the aspects of the ribbon's form and function, from launching or shutting down the ribbon to the color and size of the font and the crawl speed across the screen. In another version, different graphical animations can be used to present the event information to the user such as thought bubbles, pop-up designs, or billboards.

This invention can be understood in the context of a hypothetical but practical problem facing a CEO who is tracking his or her company's stock price while preparing for and traveling to Minneapolis where a snowstorm is predicted and weather conditions should be monitored, and the user also wants specific social networking communications and updated scores of his or her favorite hockey team. Current systems compel this CEO to identify and obtain all that information and keep it updated by constantly accessing multiple disparate sources on the Internet. In this example the CEO must visit each information source (also known as a content source) and obtain every piece of desired information separately. At least initially the CEO does this by discovering the sources via Internet searches, referrals or other means and then navigating to each website that provides the desired information and drilling down through web page after web page by repeatedly clicking the mouse or touching the screen of his or her computer or mobile device over and over again. Subsequent updates must be acquired either by directly accessing the individual websites again, or taking the time to execute generic, uncustomizable subscriptions such as RSS feeds for each piece of desired information that then delivers the information in random formats to various devices and destinations. Regardless of whether this CEO is sitting in front of his or her desktop computer or traveling with a mobile device, obtaining all the desired information, but only that specific information, is distracting, inefficient, and time-consuming. The information desired by the CEO, such as a hockey score or a weather forecast, is known as event information.

A solution is to continuously deliver all of this different information from a single source to the CEO, or any user, in a consolidated, easy-to-view and identical format on the screen of his or her office computer, mobile device, or on any other Internet-enabled electronic device to which the user may have access. Then, a glance of a few seconds will provide the information the user wants, the information will be updated continuously to reflect any changes or new information, and one click or touch will provide an additional level of detail and link to the content source if so desired.

Here is a summary of one preferred version of the invention.

MG is a web-based system from the standpoint of the user.

The customer, i.e., user, signs up at the www.metagogue.com website where his account data is entered and stored in the database.

The information choices available for transmission to the user's Internet-enabled electronic device will be displayed on the user's home page in the MG website and will reflect a broad array of popular information categories: e.g., sports, stock prices, news, shopping, business, entertainment, instant messaging, weather, email, and social networks, as well as custom choices the user may want to provide.

These categories of information will identify and offer the user multiple choices of specific and well-known web sites, i.e., content sources.

The user then selects the specific events from his or her preferred content sources to be continuously updated and delivered to their device. Events represent the specific information desired, e.g., a stock price of a particular company, the score of a particular sports event, a status update from a specific person, or news headline.

The MG database and software applications are structured to constantly query all the content sources available to the users and continually aggregate and redistribute updated event information to the users.

One application development method utilizes the content source APIs in order to identify, aggregate, and redistribute the information, especially changing event information. Additionally, recognition software can be used to detect and aggregate information graphically represented on a web page.

Only the specific information and level of detail requested by the user will be delivered. The user's selected event information is processed in the database from the aggregated content overall, re-purposed, and delivered to the user as a text and graphics crawl inside a stylized ribbon like animation application that is displayed discretely and nearly identically across the screen of any of the user's Internet-enabled electronic devices.

Any Internet-enabled electronic device with a display screen should be able to display the ribbon: e.g., a desktop PC or Mac, a laptop or other form of portable computer, a mobile phone, or tablet.

In order to change the information and/or events to be displayed on the ribbon, the user can add, remove, or change the categories content sources, events and event detail selections whenever desired, from any Internet-enabled electronic device, by simply modifying the crawl contents in the ribbon and/or accessing his personalized www.metagogue.com home page, even via the ribbon.

In the preferred version, MG assembles a vast populist array of content sources from which the user selects. In short, MG aggregates information and users c personally select from it to satisfy specific needs and interests. Then MG communicates with the user's electronic devices to continuously and nearly identically display the consolidated information in a format selected by the user, such as a ribbon like animated graphic moving across the screen of any and all of the user's devices.

### BRIEF DESCRIPTION OF THE DRAWINGS

The following figures illustrate the various methods and systems described below.

FIG. 1 generally depicts MG's homepage, user information, a user homepage, aggregation , redistribution, and display functions.

FIG. 2 depicts the MG database continually communicating with the content sources used to provide user-selected information.

FIG. 3 is a schematic of a personalized user homepage stored in the MG database and accessible to the user.

FIG. 4 depicts a smartphone with a ribbon across the bottom of the screen.

FIG. 5 depicts a smartphone with a ribbon across the bottom of the screen.

FIG. 6 depicts a schematic a user profile and user account page.

### DETAILED DESCRIPTION OF THE INVENTION

The following exposition applies to either a method or system for continuously aggregating and transmitting specifically requested information, also known as event information or event data, for display on a user's Internet-enabled electronic devices. It is described below from the perspective of a user. From a commercial point of view, the invention may be controlled by a business that provides its services to users who would acquire the services in a variety of ways including a free, advertising-supported revenue model, a subscription-based model, or an intranet sales-based model.

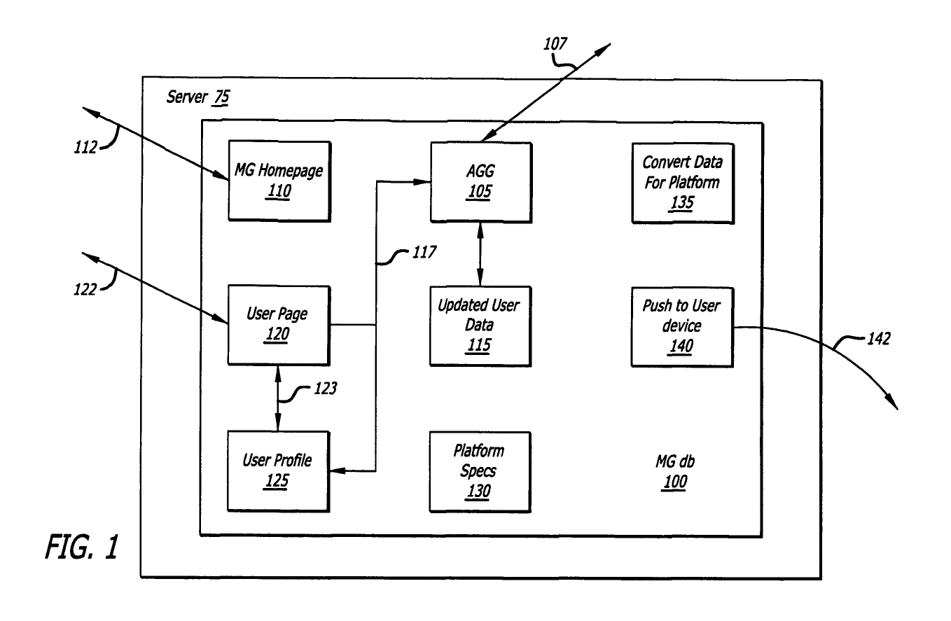

FIG. 1 depicts the principal aspects of the invention. The MG system or database 100 is stored in one or more electronic storage devices such as server 75. A user would first encounter MG through a MetaGogue Internet homepage 110 that would be accessed through server 75 and system 100. Once a user has registered as an MG user he will have access to his own personal Internet user homepage 120. User profile 125 includes information such as name, email address, identification of electronic devices that will receive MG updates, and format preferences such as a ribbon for the updates. If the user is paying for some facet of the MG service, user profile 125 may also contain payment information. Because of concerns about identity theft and other personal security issues, the detailed programming of information storage, and how databases are partitioned and secured, must be ultimately be determined at the time MG is implemented.

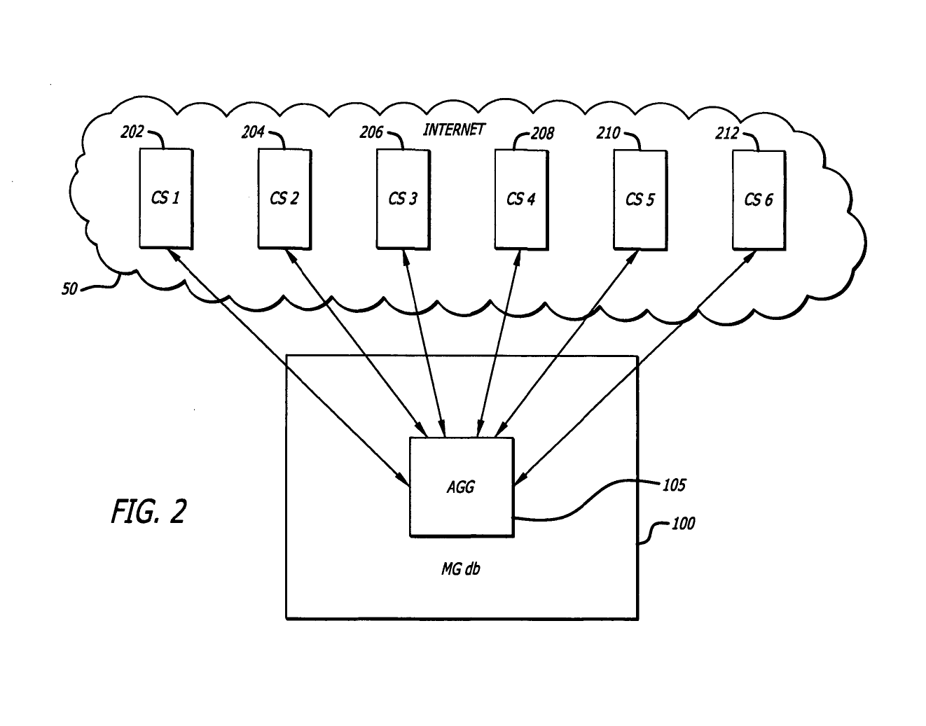

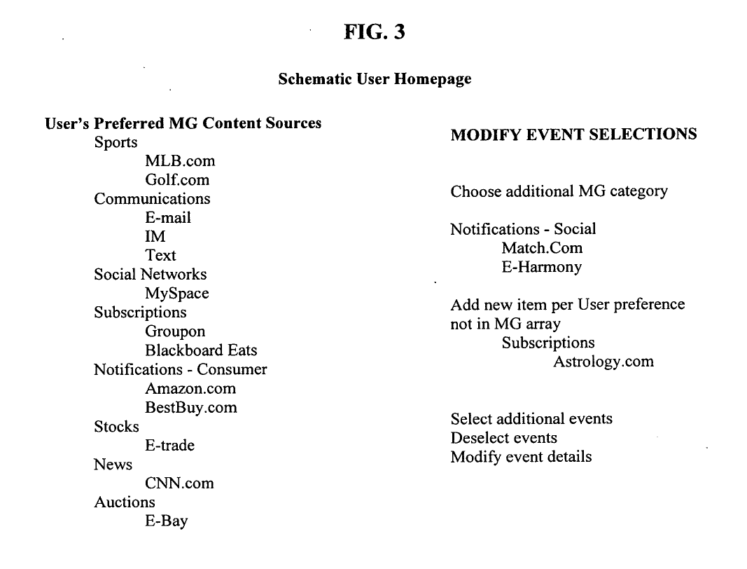

The user homepage 120 will contain or be associated with the identification of a user's individually selected content sources and any event information associated with those content sources. An example can be seen in FIG. 3, which is a schematic of a user Internet homepage that contains specific source and event information. User profile 125 and user homepage 120 will necessarily communicate with aggregator 105, which is depicted in FIG. 2, because aggregator 105 must necessarily collect personal information that is unique to the user, such as comments on a social network webpage. The communication between user profile 125 and aggregator 105 is depicted by arrow 117. Not all interfunctional communications are depicted in MG database 100, because the database structure can be implemented in a variety of methods in and in a variety of languages. Arrow 117 is an example of such communication, as is arrow 123, which depicts communication between user page 120 and user profile 125. Arrows 107, 112, 122, and 142 represent additional communication between the MG database 100 and other electronic information and devices. Arrow 122 reflects communication between user homepage 120, as it is stored in MG server 75, and the Internet webpage seen by the user. Arrow 112 reflects a similar relationship between the MG homepage 110 as it is stored in server 75 and as it is communicated by arrow 112 to the user on the Internet. Arrow 107 represents communication between aggregator 105 and various content sources on the Internet, as also depicted on FIG. 2. Arrow 142 represents MG pushing specific information to one or more of a user's Internet-enabled devices.

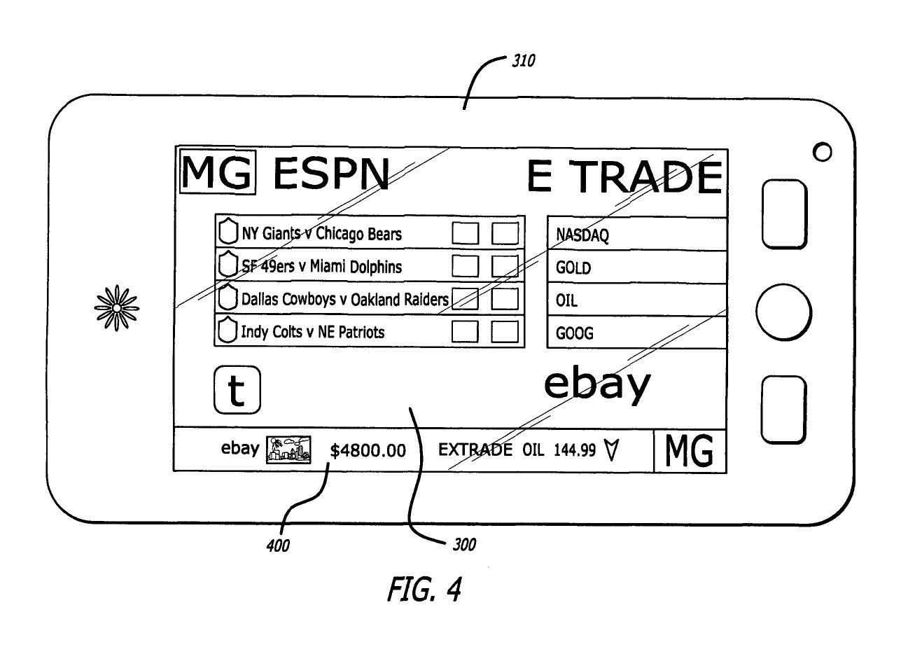

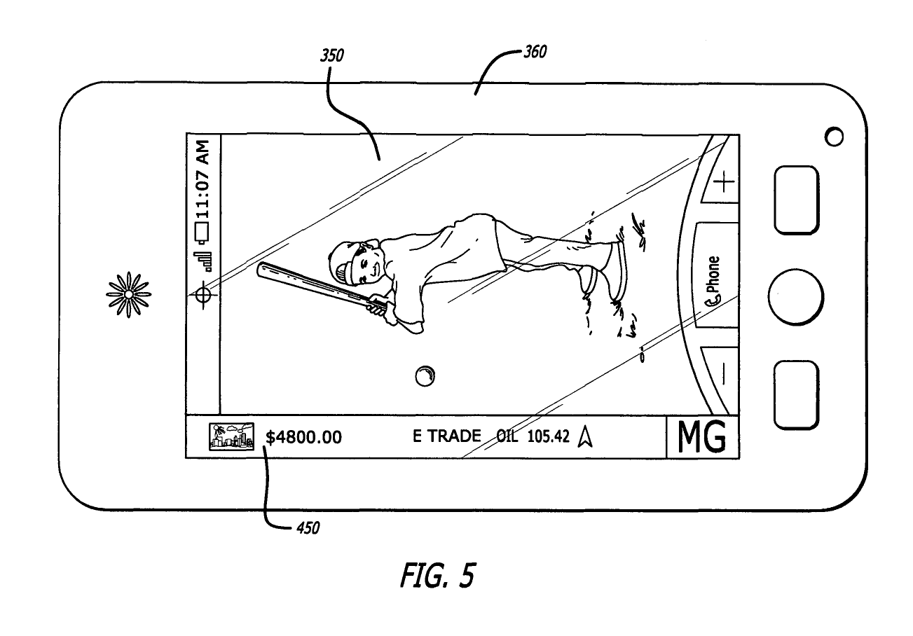

Platform specifications 130 include the information necessary for the MG system 100 to communicate with specific user devices. This information will continually be updated as new user devices appear in the market. Because of the differences among these devices, and the degree of cooperation by the device manufacturers, the devices may use a combination of hardware and software to implement MG's display function as seen in ribbons 400 and 450 in FIG. 4 and FIG. 5. In FIG. 4 ribbon 400 appears at the bottom of screen 300 of smartphone 310. In FIG. 5 ribbon 450 appears at the bottom of screen 350 in smartphone 360. The ribbons, or any other form of display, may be a device-specific application, a widget, a web application, or any other form necessitated by the nature of the user devices and the manufacturer's software and hardware.

FIG. 2 depicts the information aggregator 105 of the invention. CS1 202, CS2 204, CS3 206, CS4 208, CS5 210, and CS6 212 represent a variety of content sources. CS1 202 can be, for example, sports, news, and weather. CS2 204 can be financial information from the Wall Street Journal or CSNBC, Yahoo! stock quotes, and blogs. CS3 206 can be subscriptions, like Groupon and blackboard Eats. CS4 208 can be social networks while CS5 210 can be communications such as email, text messages, and IM. CS6 212 could be notifications. Other content sources could also be made available. Aggregator 105 can acquire information from these content sources through RSS feeds, subscriptions, the direct availability of information through a variety of well-known web languages and protocols, and, to the extent permissible, data extraction through XQL and HTQL. Ideally, many content sources will make their information available through socket programming.

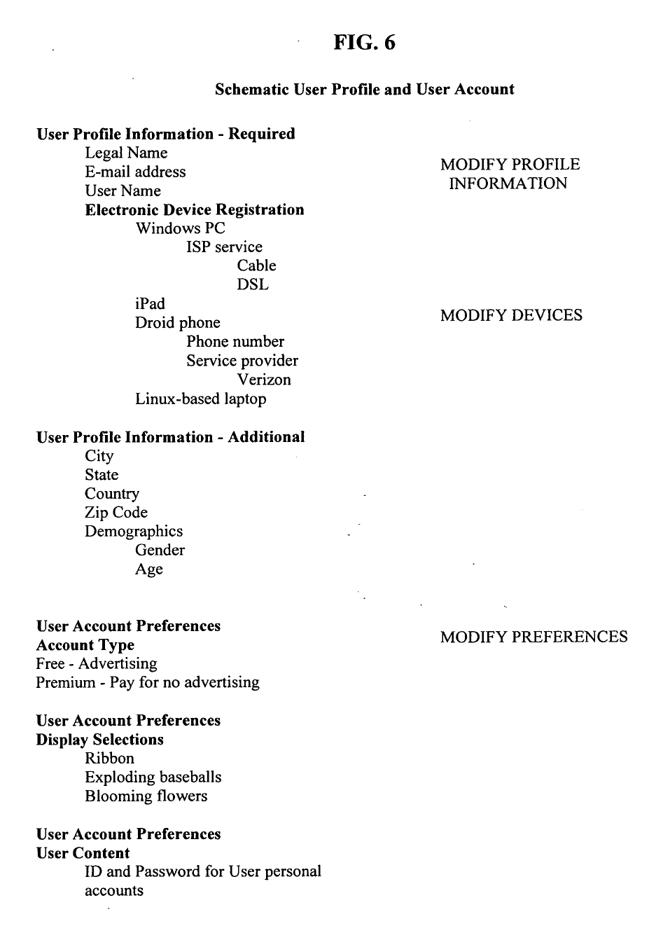

FIG. 6 s a schematic webpage of a user profile and user account with information and preferences that a user can modify. FIG. 3 is a schematic of a User Homepage that displays the user's preferred content sources with the ability to modify existing selections. As though of skill in the art will understand, the web-related, real-time functions incorporated by the present invention can be implemented by a variety of protocols and languages, including HTTP, XMPP, HTML, MySQL, Ruby on Rails, JavaScript, ATOM, and others.

Through a web-based interface the user may initially register or sign up for MG. Sign-up may include user information necessary to pay a periodic fee and for designating or receiving sign-in and password information. The term “interface” should be understood in its broadest meaning, which should be clear from the use of the word. For example, a user may practice the invention by interfacing with the Internet with his or her computer, keyboard, and mouse, or the user can interface through the touchscreen on a computer, smart phone, or tablet. Similarly, a user can interface with a web page that is part of the invention. That web page—a traditional graphical user interface or GUI—may contain instructions or request information from the user.

The system includes hardware and software that is capable of obtaining electronic information from different content sources and then storing, processing, and redistributing that information. As those of skill in the art understand, the invention may require a plurality of servers, computers, or data storage and processing mechanisms—even cloud computing—that can be utilized together in a variety of ways. The invention relies primarily on the aggregation, selection, and redistribution of information, not on the physical location of the stored data or how the data is electronically stored. The totality of the stored information is a database comprised of different types of information and applications that are described below.

Typically, the user will navigate to the www.metagogue.com home page on the Internet and be directed through the registration procedure. There the user enters typical demographic and personal information while creating login IDs and passwords. Then, the user identifies the Internet-enabled electronic devices that will receive the personalized event information, communications, and updates that the user desires. In the preferred version of the invention, MG is set up to deliver the user's requested information in an identical user interface to each of the Internet-enabled electronic devices identified by the user, even if they represent different platforms, e.g., iPhones, Blackberrys, Droid phones and tablets, Apple computers and iPads, Windows PCs and tablets, etc. In one version of the invention, MG prompts the user to select devices from a list on a webpage. All of this user supplied information is stored in the MG database as user platforms. The user's platforms are the same as his Internet-enabled electronic devices. In some instances the screen displaying the event information will be an integral part of the Internet-enabled electronic device, as in the case of mobile devices or laptops. In other instances the screen may be a device peripheral to an Internet-enabled electronic device that receives information from the MG system, e.g., a desktop computer. The invention is not limited to the Internet-enabled electronic devices identified by the user during their initial registration. A user will obtain new Internet-enabled electronic devices and discard old ones and will want to control and update his devices that receive information.

When the user wants to select the desired and specific information that will be transmitted to his or her Internet-enabled electronic device the user proceeds to their private “home” page on the www.metagogue.com website where the user can personalize and select specific content sources and individual events. As with the sign up platform choices, the preferred version of the invention offers the available content choices on the user's “home” page, which the user then can modify repeatedly and as often as desired, creating his own unique, personalized version of MG for ongoing use. The invention also provides the user with the choice to receive information for multiple events over an extended timeframe. As an example, for an event such as a baseball game the personalized home page may offer an array of content sources from which to obtain the information: e.g., websites of ESPN, CNN-Sports Illustrated, MSNBC, the Major League Baseball website, etc., and the broadest possible range of selectable events such as the score of one baseball game or all of the baseball games on a particular day, or even for a particular team for the whole season. For example, a Los Angeles Dodger fan can elect to receive real-time updates of today's Dodger game, or every Dodger game throughout all or a portion of the baseball season. Likewise, the user can designate additional teams whose scores the user would like to follow, and alternatively, the user can also include in their request a score from a different sporting event, such as a soccer match. The user can also select any or all of the static or dynamic event data desirable to follow the event. In the case of a baseball game this includes the sport, the game time and date, the teams, the score, what inning, statistics, etc. The user's content source selection and event data requests are stored in the MG database.

That same Dodger fan, who may be like the earlier CEO tracking his company's stock, can follow a similar procedure for obtaining continuous updates on the stock transmitted within the same text crawl to their ribbon. Likewise, the user may elect to receive continuous weather updates or multi-day forecasts, news about a specific world figure, social network updates from specific friends, and communications from a professional corporate manager society. In each case MG preferably provides a large selection of varied content sources and permits the user to select specifically designated events or even request their own. Some content sources may require the user's login and password for that site. When content source and event data selections are made by a user, MG, where necessary, will also have the user provide all the information necessary to log in to the content sources user's login and password.

Once the user has entered all of his or her personal information, identified his or her platforms, chosen a graphic format such as the ribbon, and selected his or her content sources and event data, and, the system begins to provide the user with specifically selected information. The available content information from all of the content sources is continuously aggregated and stored in the MG database. Then the system receives the request for event data chosen by the user and simultaneously identifies the user's profile in the MG database. MG utilizes its continuous queries to the content sources supplying login and password information if necessary, accesses the user's specific requested event data from the MG database, and processes the requested information, such as a baseball game (e.g., teams, inning, score, pitchers), for re-distribution in real time to the user. The baseball game and event data are continually updated in the database and any changes or updates will also be delivered in real time to the user's device. Then the system reviews the user's profile to identify the user's Internet-enabled electronic devices and platforms for delivering the customized event information. MG formats the information for insertion into the crawl and transmits the new or updated information to the ribbon, which then displays the real time event information nearly identically on the screens of all of the user's Internet-enabled electronic devices. As previously noted, the preferred display is a ribbon flowing across the top or bottom of the screen, with the crawl inside the ribbon, but other display formats can also be used. The format selection and control can be implemented either through the Internet or through an application on the user's device. If the user's device or the ribbon interface is shut down, the request is still processed and transmitted, and the crawl will update immediately upon re-launching the ribbon. Finally, MG repeats the process continuously; aggregating information, checking for user requests for additional events or event data—additional sports scores, weather, news, etc.—and processing & formatting the requested information from the database into the crawl for delivery in real time to the ribbon on the user's devices. As information changes and updates at the content sources, such as a weather forecast or the score of a baseball game, the changes will be identified in the event data MG perpetually aggregates from the content sources and subsequently transmitted to the crawl within the ribbon on the user's devices. Only a tiny fraction of a second is required for MG to receive a user's request or associate the existing request with an event update, review the user's profile, collect the specifically requested event information from the database, then format and transmit the information to the crawl and ribbon on the user's devices. If a content source provides real-time information, then the user will receive real-time updates about the selected events. A user may desire to modify or discontinue receiving some or all of the events or event information. The interface between MG and the user preferably should provide such an option, and will be accessible from any and all of the user's Internet-enabled devices.

As those of skill in the art will appreciate, MG functions in a more complex manner than the examples described above. MG will simultaneously provide services for thousands or even millions of users. This requires numerous computers or servers, large databases, and software applications to manage the databases. Those of skill in the electronic arts will understand that the MG infrastructure can be configured in a variety of ways, both in terms of hardware and software. They will also understand that MG may be configured from pre-existing hardware and software packages, if desired. For example, there are a variety of software packages for database management and manipulation that are available for purchase. Some of these are even available as open source applications, such as MySQL. Alternatively, one might choose to program some or all of the MG functions without resort to commercially available software packages, and that programming can, if desired, be open source. In either case, modern hardware and software technology permit MG to simultaneously perform many functions for many users.

Also, because of the flexibility of the hardware and software aspects of the present invention, the method of practicing the invention need not necessarily be performed in the specified order of the steps described here. How the different MG operations are programmed and organized is a matter of choice for those of skill in the art, web page designers, and those administering the MG business. So, too, is how or where a user enters information. Likewise, the user may interface with MG in a plurality of ways. For example, the user may interface with a website, a widget, a specific desktop or mobile application that can be downloaded, or a product that can store the application on any data storage medium such as a CD. In some cases, a user who is not computer savvy may have someone else enter the user's desired information and instructions for delivery of the information. Therefore, in some cases the term user could conceivably encompass two or more individuals. Likewise, to access the system, the user may employ any form of computer or mobile device that can communicate remotely with the MG database. In one version of the invention MG can provide the user with the option of not selecting a specific content provider but only a general type of content category, e.g., sports or news, in which case MG will select the content provider.

The commercialization of the invention will likely involve a variety of embodiments. For example, both the user and the supplier of the MG service can control a portion of the ribbon content. The supplier of the MG service will determine to what extent the user can control the appearance of the ribbon. Because advertising revenue is the sine qua non of most Internet businesses, the MG supplier may elect to insert advertising into the ribbon. How, where, and in what format the advertising appears in the ribbon will affect the degree of control the MG supplier gives the user. For example, the user can select whether the user wants a ribbon continuously streaming across the screen or whether it appears on a periodic basis, such as for one minute out of every five. The user can select color of the ribbon and the size and style of the font. From the commercial perspective, the entity controlling MG can insert well-known trademarks and logos or special graphic icons aka “Adicons”, or audio clips i.e. commercial jingles, music samples, etc. aka “Audicons”, into the ribbon as advertising. Alternatively, the MG supplier could provide the user with the option of paying a fee to not receive advertising. With that option the MG supplier might provide the user with a greater degree of control over the appearance of the ribbon.

MG can provide the user with other personal choices for display and varieties of content sources. For example, MG can also be programmed to display information in formats other than ribbon form, such as a thought bubble, screen inside a screen, or a billboard. The ribbon format is, after all, simply the animated graphic interface displaying the aggregated information selected by the user. The nature of the formatting is limited only by practical and technical considerations.

What is claimed is:

1. A system for continuously aggregating and redistributing user-personalized electronic information for display on a plurality of internet-enabled devices, comprising:
an electronic data storage ;
an electronic database including
a series of internet web pages including a front page and customizable user home pages with content choices adapted to be accessed by a user on the internet,
an information database comprising information collected from a plurality of both pre-determined and selected content sources,
an information aggregator adapted to continuously communicate with each content source and populate the information database,
device profiles defining a plurality of internet-enabled devices,
a user profile including a selection of at least one of the internet-enabled devices,
user requests defining specific information from the information database that the user wishes to have displayed on at least one electronic internet-enabled device,
means for transforming the user requested information for display by the at least one internet-enabled device; and,
means for transferring the transformed user requested information to the internet-enabled device for display by the internet-enabled device.

2. The system of claim 1 wherein the display of the user requested information is a continuous ribbon.
